(19) United States
(12) Patent Application Publication
(10) Pub. No.: US 2012/0179557 A1
(43) Pub. Date: Jul. 12, 2012

(54) Performance Based Internet Reward System

(76) Inventor: JOHN NICHOLAS GROSS, BERKELEY, CA (US)

(21) Appl. No.: 13/348,330

(22) Filed: Jan. 11, 2012

Related U.S. Application Data
(60) Provisional application No. 61/432,114, filed on Jan. 12, 2011.

(51) Int. Cl. G06F 15/16; G06Q 30/06; G06Q 30/02

(52) U.S. Cl. 705/14.73; 709/206; 705/35

(57) ABSTRACT

A networked computer system allows content submitters to have their submissions rated and evaluated by members of a social networking sitev. Winners can be determined by evaluating votes cast by other members in favor of the submissions.

### RELATED APPLICATION DATA

The present application claims the benefit under 35 U.S.C. 119(e) of the priority date of Provisional Application Ser. No. 61/432,114 filed Jan. 12, 2011 which is hereby incorporated by reference.

### FIELD OF THE INVENTION

The present invention relates to systems and methods for entertainment and e-commerce systems.

### BACKGROUND

A number of prior art Internet social/networking sites permit users to post and share content between members, such as found for example at such companies as Twitter and Facebook. In some instances members are allowed to express their approval or appreciation for a content item by expressly providing a “like” tag to the item in question. Still other sites have permitted members to post content such as photos or text which are then rated by other members, such as a service offered by hotornot. This site compiles statistics on member submissions and provides rankings of the perceived relative aesthetic appearance of members as presented in member images. Finally, there are also certain charity sites online that allow members to express a request for financial assistance in the form of gifts, donations or microloans.

None of these prior art systems or methods allow users to create and designate a specific item of content as part of a pool of items to be considered and voted on as a whole by a larger community to determine winners for financial assistance.

### SUMMARY OF THE INVENTION

In aspects of the present invention, users provide content to a performance based polling system. Winners are determined based on a number of different parameters, including considerations of factors outside of simple vote tallies. Other aspects of the invention concern collaborative works, and mechanisms by which users can create the same.

### DESCRIPTION OF THE DRAWINGS

FIG. 1 illustrates a process used by an online interactive game show implemented in accordance with an exemplary embodiment of the present invention;

FIG. 2 depicts a block diagram of a system implemented in accordance with an exemplary embodiment of the present invention.

FIG. 3 depicts a preferred process for creating a collaborative work which can be used in embodiments of the present invention;

### DETAILED DESCRIPTION

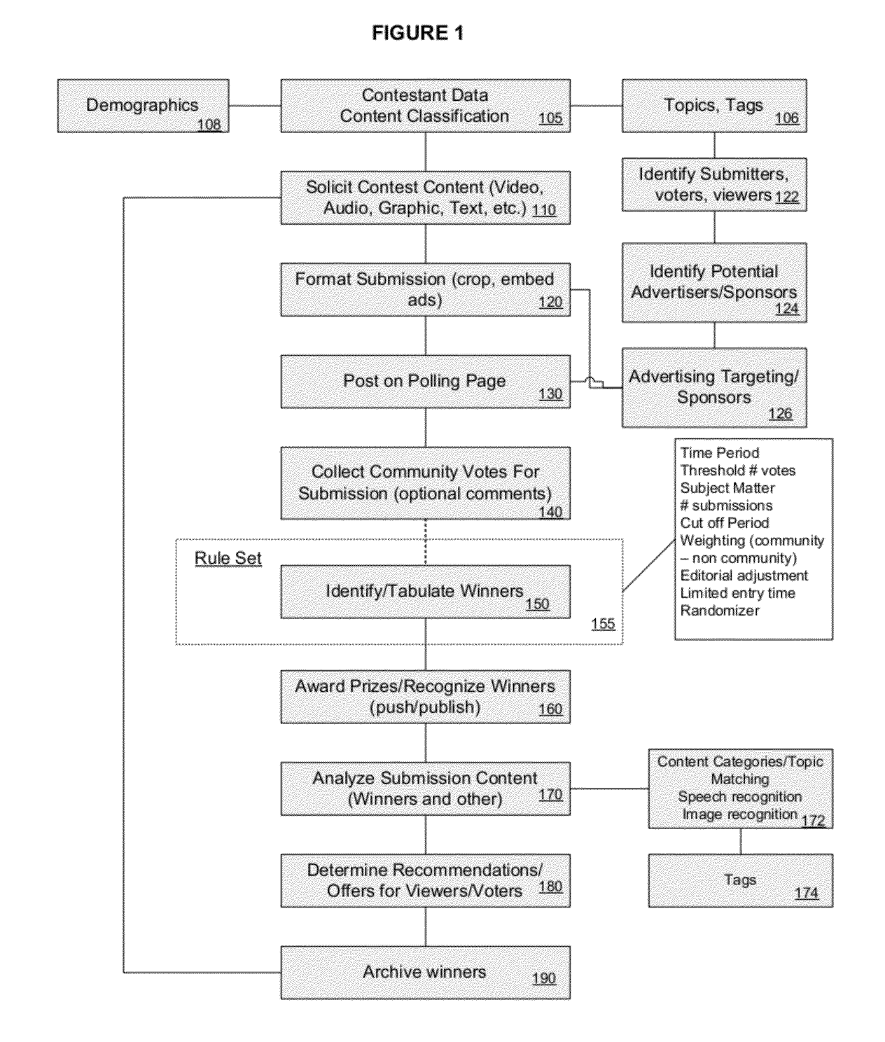

FIG. 1 illustrates an example of an overall process 100 used by an online interactive game show that is adapted for allowing users to generate, post and be evaluated on their submissions by a larger community of online users, which may be part of a social network site. In a preferred embodiment the inventive process is implemented on a server computing system consisting of computing devices/hardware and associated software routines adapted for interacting with users across a network such as the Internet. The process is preferably implemented by distinct processing modules in the form of a set of one or more software routines executing on a computing system, which may comprise a number of interconnected or networked computers accessible over the Internet. The modules may further be embodied and stored in tangible machine readable form on electronic media for ease of distribution.

The general notion, as alluded to above, is to permit users to provide content to a performance based polling system where it can be seen and assessed/ranked by other users. Winners are determined by either the members of the system, or other ranking systems as desired/devised by a contest sponsor site. Preferably the content includes video submissions authored by a human user/artist articuling a specific request for financial assistance, which request may be based for any desired purpose, ranging from humorous to mundane. The expression by the user of the request and the purpose of the request may be humorous or serious, and may be include the use of appropriate props, actors, dialog scripts, etc. to enhance the aesthetic appeal of the submission.

At step 105 the user (contestant) provides identifying information about themselves, which, preferably includes at least some basic demographic data 108 (age, gender, domicile) but could include more detailed data such as name, address, email contact, etc. Other data could be collected as well about the content itself, such as a description of some sort. The contestant also may be prompted to provide a specific category/topic tag 106 for the submission as well (i.e., $ for a new pet, $ for a new toy, $ for a date, etc.) Division and organization by specific language, age, gender or interest may also be employed in some instances to better segment and target communities.

The content is then solicited and obtained at step 110. In a preferred embodiment the submission is preferably in the form of a short video clip authored in some artistic, aesthetically pleasing form by a human, but it will be understood that other media forms could be used, including audio, image data, text, etc. The use of video clips is expected to be more popular since people tend to have a stronger visceral reaction to a live presentation from another person. The emergence of smartphones which can instantly upload content to social networking sites allows for the greater proliferation and enabling of this technique as well. To facilitate creation of content, an automated software discovery agent can monitor sites such as Youtube on a daily basis to identify users who have posted content which has attracted large numbers of views. The discovery agent can be developed using a number of conventional tools, and be programmed to look for specific types of content, from specific types of users, and with a threshold number of views.

The content submission may include other relevant metadata as well about the user and the associated content, including geotagging information, location (establishment) information about a situs where the content is created, date, time, camera/phone ids, etc. In some instances an establishment (which is near or at the location of the user's performance) can be identified (by any conventional mechanism) within the submission as it is viewed later by voters or viewers. For example, a graphical text overlay may be included to give credit to a particular establishment, such as with a phrase that states “This performance was created at or near XYZ's place.” In preferred embodiments the establishments provide a predetermined amount of consideration to the contest operator for being credited within the submission, and/or placement of their logo or other identifying information. Additional consideration may be given to contestants who agree to endorse a particular product or service offered by the entity. Other techniques will be apparent to those skilled in the art. The tagging of the establishments or locales can itself be used for the collection, organization or review of the submissions. The commercial entities associated with the brick and mortar stores can further use the collection of submissions to promote themselves, such as by creating customized channels of content/entries that are tied to their establishments in some fashion, publishing the fact of new submissions associated with their locales, etc.

Again in a preferred embodiment the theme and focus of the submissions is based on users expressing a need for monetary funds or some other form of remuneration (such as online virtual credits, event tickets, electronic coupons, etc.) for some specific purpose, including charity. The purpose, as noted earlier, can be based on any subjective or idiosyncratic need of the contestant. It is expected that in some embodiments of the invention, contestants may be organized according to a “purpose” tag {C1, C2 . . . Cn} to allow for other members to more easily parse and vote on items in categories of their interest. For example some users may want to vote for persons who are specifically pleading for money to start up a business, or who are looking for a specific job position, etc.

In some embodiments the invention may be used to permit individuals to present content that responds to one or more target questions as part of an abbreviated job interview, or as part of pitching an idea for a new business/company, etc. Talent agencies may also use the system to screen would-be actors, musicians, singers, etc. The agencies can present specific content or dialog to be read or performed to determine the performer's attractiveness or utility in particular roles. In still other embodiments the contest may require that the contestants respond to a particular question (“what do you think the President should do about Afghanistan”?) or present content on a particular theme (“Why do you like company ABC's new ostrich burger”?) and so on. Again any number of relevant, timely topics can be chosen to solicit material of interest to an online community. Other embodiments of the invention may allow the community to identify and present particular challenge scenes, songs, questions, etc., that must be performed within the submissions. These so-called “community challenge” contests can be run in parallel or in lieu of regular unconstrained contests as alluded to above.

In most cases the prize funds for the contestants are provided by the site operator, and may come from any number of sources, including from advertisers and sponsors 124. In some embodiments the members themselves can pledge or donate funds to the contest to increase the size of the prize as part of step 110. For some embodiments it may be desirable to let organizations “match” particular prizes to increase the overall prize pool.

At step 120 the submission may be formatted in accordance with the requirements of the contest/system. For example, a video submission may be cropped to be below a certain size limit, such as a file size, or time duration. Other formatting may be implemented to permit the submission to be presented within a particular web page format. In a preferred approach the videos are kept below a reasonably short period such as 1 minute, 30 seconds, or the like to preserve storage, bandwidth, etc., and to increase exposure by members to more selections. The description and other metadata provided by the contestant may also be edited or filtered as desired. Additional operations such as to embed advertising can also be performed at this point as well. For example an ad relating to snack or food products or a newly released movie may be presented within a submission presented by a young adult requesting money for a date. Techniques for overlaying and embedding ads within video, audio and other multi-media content items are well known in the art.

As seen at step 122, the submitters, voters, viewers, etc., are identified or estimated for one or more particular submissions. Advertisers and sponsors are identified and compiled at step 124 based on the topic, tag or other determination of the submission content, the submitter's characteristics, or the community/page in question. Other data can be considered of course as well. The specific ads are then targeted at step 126 for presentation within a particular webpage on which the submission appears, or within the content itself as noted earlier. For example in submissions concerning requests for money for school supplies, one sponsor may be a backpack manufacturer, a lunch box manufacturer, etc.

Assuming the submission otherwise passes other requirements instituted by the contest provider, a polling page is then updated at step 130 to include the submission in question. In addition it may be useful or desirable, in some instances, to publish the fact of the submission to a user's private social network page/news wall/social network as well to bring it to the attention of other other social networking site members. Again, as seen in FIG. 1, the provider may elect to show advertising both within the page as well as the submission itself. In a preferred embodiment the polling page is a public page on a social networking site such as Facebook, which can receive uploads directly from members through a smartphone using a standard application. However it will be understood that other implementations are possible of course and will be apparent to skilled artisans from the present teachings.

At step 140 the submission then is subjected to review and can receive “votes” from members of an online community. Again the act of voting itself for a particular submission may be an event that is posted in the voter's private social network page/news wall/social network as well to bring it to the attention of other other social networking site members. The “votes” may be tabulated using any known polling method, including by simply recording the number of “likes” received by a particular post within a social networking page such as implemented by some social network sites. Other comments, feedback, etc., can be presented as well as desired by the voters for the submissions. Where desired or necessary, verification/authentication mechanisms can be implemented (e.g., captcha, re-captcha or the like) to confirm the authenticity of a vote. This can prevent automated robots and other spam agents from distorting or even contributing to a vote tally.

In a preferred embodiment, the contest is divided into different phases, such that the voting occurs across different time periods within a contest cycle. In a first phase, the contest is initiated, submissions are collected, and voters can vote on them as well. At the end of this first phase (which may be of any convenient duration) the entries are evaluated (again, preferably by vote count) to determine which ones are to be deemed eligible for a final round of voting. This second phase may be considered as a “curating” phase during which the contest operator can assess the entries, confirm the validity of the votes, etc. In some contests, to encourage diversity, it may be desirable to select the top N entries from M categories (N*M entries) rather than simply the top overall N*M entries across all categories. In some instances the preliminary candidates may be given additional votes by a judging panel, or by the contest operator, to finalize the set of entries to be considered for the final round. For some selected entries that may have been entered late in the cycle, the contest operator may consider a momentum (votes/time) factor to decide to include it even if they were not part of a nominal set of top vote getters. In this manner the composition of the final set of contestants can be optimized to reflect accurately the true interest of the community. Again in some instances a contest may be completely automated so that a determination of the next round contestants is done by the computing system without human intervention or input. It should be apparent that the format and rules for inducting the entries into the next phase can be customized for any particular contest requirements.

During a third phase therefore, the initial set of entries has been reduced or filtered to a smaller subset of final contestants who are eligible to win prizes. To further enhance fairness, the entries may have their vote tallies re-set to zero, so that all entries have an equal time start. This is in contrast to the first round of voting, where, as noted earlier, due to the differences in time for which the submissions are presented, it is possible that certain popular titles may not otherwise make a final cut due to coming up short in the overall tally. The format of this second round of voting preferably ensures that all qualified contestants are given equal treatment.

At the end of the third phase the votes are again tallied to determine a set of final winners during a fourth phase, which can be characterized as a final winner resolution phase. Again during this fourth phase the contest operator can verify votes and perform any additional other desired vote weighting to determine the final set of winning submissions.

Further expected benefits of the two-stage voting process include the fact that voters on submissions are re-engaged and encourage to vote for their favorite entries a second time. This increases site traffic, as voters and viewers must re-validate their original vote(s). In addition, the returning voter is exposed to content that they may have missed the first time, since they could have voted for entries early on in the first phase. Furthermore since the content for the final round of voting has been curated to include only the most popular entries, this reduces the amount of extraneous (or limited value) content that the user must peruse. For this reason the experience for the returning voter should be greatly enhanced.

In some embodiment voters in the community are allowed to view content in common, or at the same time, within predefined or customized chat rooms (not shown). The chat rooms allow viewers to exchange comments in real-time as they perceive the content as part of a shared experience. For example, a first community chat room may be set aside which only shows submissions within a first category (charity) and so on. Other chat rooms can be set aside for other rooms of course. In other instances members/voters can create their own customized chat rooms where they can peruse content with their friends or other members of their social graph as part of a group experience. In some embodiments of the invention it may be desirable to permit contestants to contribute their collected votes to another candidate in the event they are not selected as one of the initial or final winners. In this manner the contestants can control (to some degree) the outcome using an altruistic voting model.

Again other techniques for tallying votes will be apparent to those skilled in the art. As an example, in a TWITTER like environment, the number of “votes” could be based on identifying a number of persons who create posts referencing the submission, or create a hashtag for the submission, or even those who repeat (re-TWEET) another members message referencing the submission. It should be noted that the “votes” or likes contributed by members of the site for the submissions can be used to augment/construct a social network graph. This data can be used therefore to provide suggestions or recommendations to a voter for new friendships, new content, etc., or be used to filter/tailor search results. In some embodiments voters can also choose to “follow” particular contributors, so that in future contests content from such contributors can be automatically brought to the attention of the voter, including by message, email, posting in a news feed, or any other known mechanism.

The performance of the submission may result in the contestant being identified as a winner at a submission evaluation processing step 150 in accordance with a rule set 155. The rule set 155 may include any number of factors as noted in FIG. 1 as part of the consideration in identifying a winning submission. For example:
the system may only consider items presented before a certain cutoff period in its deliberations;
the system may require that a submission receive a minimum (threshold) number of votes before it can be declared a winner; in some embodiments, when an entry is getting close to a winning threshold, an alert can be automatically generated to the contestant's social graph members (preferably those who have not yet voted) to encourage them to vote and assist the contestant;
the system may “extend” the contest voting duration when it appears that one or more contestants will not succeed within the nominal contest voting period, but they are close enough that they are likely to get enough votes to surpass the threshold within a certain number of additional hours, days, etc. This “extension” period can be promoted as well, again, to drive and increase traffic to the site to help individuals succeed in winning higher level prizes than they would normally (nominally) otherwise achieve.
the system may specify that a contest is automatically terminated based on any one submission receiving the treshold number of votes;
the system may specify that only a certain finite number of votes for all submissions is to be considered, so that after the first 10 k (or other arbitrary number) votes are received, no more votes are processed for a particular contest cycle;
the system may lock out contestants from submitting more than one submission in a particular period; this may be enforced by monitoring and recording a user's identification data, device identification data, etc.;
the system may filter or deny certain submissions from being published based on potential offensive, embarrasing or obscene subject matter;
the system may bias or prefer content in particular categories in particular periods; for example submissions directed to requests for funds to attend a concert may be favored when the event is to take place in the near future at a particular locale;
the system may weight input from a content provider, an advertiser/sponsor or other external input in addition to the community voting to determine a winner; similarly some community members may be given “extra” voting power depending on their status, value, reputation or authority within the community;
the system may elect to impose a cut-off period so that only the first X submissions can be considered within a particular time window, to incentivize contestants to be prompt with their submissions; in such instance the submitters may not be able to see their submissions posted/published right away, as the system may hold them in abeyance pending determination of the final contest sample/pool to be used during any particular contest period;
members of the community preferably can vote for more than one submission, but may not vote for the same submission more than once;
a merit panel of one or more judges can also be employed in some embodiments, in a manner akin to other conventional TV programs; in the present embodiments, however, the judges preferably do not determine the ultimate winner on their own, but rather have limited/different powers than in prior art programs. For example they may be able only to recommend entries/contestants, and not vote on it; or alternatively, they may be empowered with a number of votes (N, where N could range by orders of magnitude) that they can cast to one or more contestants, either singly or in block form (i.e., >1 vote for a particular contestant);
the votes can be time-stamped as well; the resulting member/vote/time entry can be used for later data mining operations, such as to identify members who are active in reviewing content, members who are accurate predictors of likely winners of contests (i.e., trendsetters), etc.
while the preferred manner of voting is a simple unary value (“like”) for the submissions it will be apparent that numerical rankings may also be provided in some embodiments;
in the event of significant numbers of submissions, the system may impose a throttle of some kind, so that some entries are deferred or tabled for publication until a later date; this technique may be accompanied by some random determination of which entries to use in any particular cycle, with increasing weighting given with age to entries so that each unpublished/unposted submission is effectively guaranteed publication within a certain number of contest cycles.
The polling page may also present one or more visual graphs or dynamic tabulations of the contest entries for the enjoyment of members. For example, each submission may be given a unique entry number along a first axis, and the number of votes for such entry can be shown along a second axis. In addition, members may be allowed to see a voting pattern/behavior over time for each entry to visualize a time based trend of popularity. Other examples will be apparent to those skilled in the art. A graphical interface within the page preferably permits users to easily select and manipulate the entries and graphs using any number of well-known software and hardware based techniques.
In the event a contestant does not win with his/her entry, they can be allowed in some cases to roll over the same entry into a subsequent contest. In some case the system can automatically roll over a limited predetermined number of popular (but non-winning) submissions as a quick and efficient way to re-stock the viewing content for the contest. The re-stocking/rollover is preferably done so that each different category type includes items that are initiated within the new contest.
By examining voting behavior it becomes relatively simple to identify other related content that the viewer will probably like, using conventional collaborative filtering, or content filtering prediction algorithms.

While the preferred embodiment uses a social networking page to compile reviews and votes, submissions may be presented as items within a TWITTER “feed” as well. In the latter case the number of “re-tweets” can be used as an indication of an endorsement or “vote” for a particular item. In other environments votes can be determined with reference to other considerations or actions by users/members. The progress of the contests can also be presented in an ongoing Twitter-like stream to keep other social membership groups apprised of the contest voting. For example, a top 10 list may be published periodically, or the surpassing of certain milestones (>1000 votes for example) may be published as well for public consumption.

At step 160 the winners of the contest (to the extent there are any during the context period) are announced. This information can be published on a contest provider site for public consumption, and/or by private messages through email, electronic messages, wall postings, etc. In addition, running tallies can be compiled as well across multiple contests to acknowledge longer term trends, contributors, etc. The nature of the winning submissions can also be tabulated, for example, to identify trends, such as the tendency of members to reward other members seeking funds or remuneration for specific causes (i.e., $$ for movies, for dating, for specific personal products such as electronic devices, etc.). These trends can be mined as well to identify and tabulate a community's collective mood towards specific subjects/topics. For example in late January it can be expected that members may react more favorably to solicitations asking for funds for a Valentine's gift, and so on. Other examples will be apparent to those skilled in the art. This data can be used in subsequent contest cycles to filter and select submissions that are more likely to be desirable for the online community. The compensation received by the winners can be in any desired form for the contest, including cash, virtual currency, electronic credits, coupons on free or discounted offers, tickets for entertainment devices, etc. It is understood that almost any form of compensation can be used in the present embodiments.

An additional step 170 is also preferably performed to analyze the submission content, to identify categories of content, and to perform additional operations such as perform image recognition, speech recognition, etc. This step may be selectively performed for only some of the entries, such as winning entries, depending on system needs and requirements. The resulting recognized image data (which may be faces of members or other users, or objects) and speech recognition data (which may be in the form of text) is further classified with tags at step 174. For example, there are a number of well-known sites that offer products which perform facial recognition. In some instances the user's content might be mined and automatically mapped to distinct categories or tags (e.g., source selected tags that are included with a message; in the case of Twitter, they are referred to as “hashtags” as they are included with the text of a message and set apart by a hash mark; more generally, they are source-selected tags) without consultation.

The tags 174 can be used to automatically augment a social graph for the submitter, for the voters, or to automatically create postings/publications for the submitter/identified image target. As an instance, this “recognized” submission data can be used to create an automatic post on a member's page or newswall when that member is identified in one of the submissions. In the event of a submission being declared a winner (of some sort) the member may receive an additional public award or acknowledgement as well to recognize their performance.

At step 180 the submitters, voters and viewers (people who may seen the submission but did not vote) can have their social graphs adjusted based on the content of the submission, and the correlation of submitters/voters/viewers. For example, a first type of link may be created between members “liking” another member's submission. A second type of weaker link may be created between members simply “viewing” another member's submission, and so on. The system may create a third type of link that takes into account the performance of the submission itself within the larger community in determining the extent/strength of the link in the social graph. That is, a submission that attracts a large number of votes may be considered more likely than one with significantly less votes to cause social linking that is rewarding and longer lasting between two members. A reputation of the submitter may also be factored into the updating of the social network graph for the members. All of these parameters may be used to adjust the strength of a social graph link between individuals. The links can then be used by an automated recommender to recommend friendships, relationships, people to follow, other content, advertising, search results, etc., as is well-known in the art. As used herein, the term “recommender” is intended in its broadest sense to refer to an automated computing system that can consider users, content, etc., and develop correlations between the two for the purpose of providing a suggestion or recommendation to a user. Customized channels can also be set up or automatically generated for the users based on observing their voting behavior/viewing preferences.

The submissions are preferably archived at step 190. In some instances it may be desirable to only archive winning submissions to save space and reduce administrative overhead. As noted earlier the system can track long term results as well and publish lists and tabulations for community enjoyment, such as leading vote getters, leading prize winners, etc. The performance of “voters” can also be measured and tabulated if desired to identify members who over time tend to be accurate predictors of winning submissions. The voters in turn can be “recognized,” as noted above, through express acknowledgements on their social networking pages, such as by posts which indicate “XXX accurately predicted NN of the ZZZZ contest winners” and so forth. Other variants will be apparent to those skilled in the art.

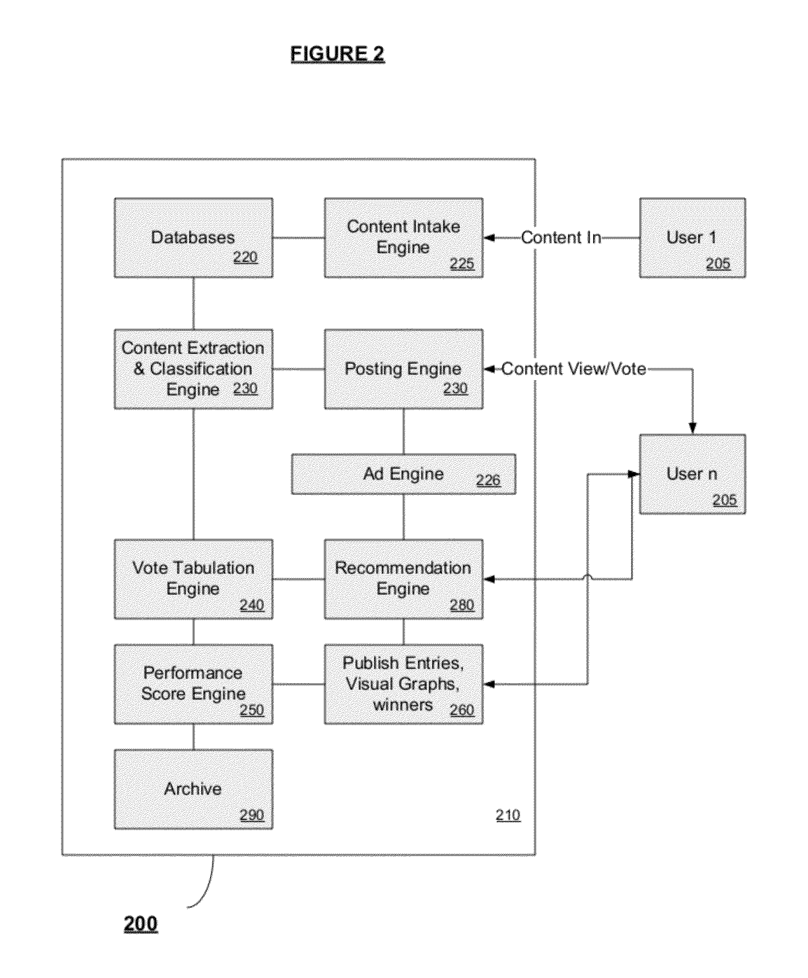

A preferred embodiment of a computing system employing and supporting the aforementioned preferred processes depicted in FIG. 1 is shown in FIG. 2. As seen herein, a server computing system 210 is preferably a collection of computing machines and accompanying software modules of any suitable form known in the art for performing the operations described above and others associated with typical website/social networking page support. The software modules described below (referenced usually in the form of a functional engine) can be implemented using any one of many known programming languages suitable for creating applications that can run on client systems, and large scale computing systems, including servers connected to a network (such as the Internet). Such applications can be embodied in tangible, machine readable form for causing a computing system to execute appropriate operations in accordance with the present teachings. The details of the specific implementation of the present invention will vary depending on the programming language(s) used to embody the above principles, and are not essential to an understanding of the present invention.

As seen in FIG. 2, a number of users N 205 access the computing system over a network (such as the Internet) to post, review and vote on the submissions described above. To simplify the description, only two users are shown but it should be understood that at any moment in time the number of users can be thousands or millions depending on available computing resources. As seen in FIG. 2, a first user 1 contributes content over the network to a content Intake Engine 225 which, as noted above, may process the data in accordance with the discussion for FIG. 1 noted above to effectuate the operations associated with steps 105/110 to solicit user data, and analyze and format the submissions.

The resulting information identifying and correlating submissions, contributors, timestamps, votes, views, etc. are stored in any number of conventional databases 220 which may be relational databases to optimize speed, data compactness, etc. A Content Extraction/Classification Engine 230 further cooperates with Content Intake Engine 225 and Databases 220 to analyze the stored and incoming submissions and votes to identify topics, information units, contributors, etc., as discussed above for FIG. 1 (steps 106) and the information shown at 116/117. This engine may include speech recognition, image recognition, etc., and also is responsible for the operations noted for steps 170, 172, 174 (FIG. 1).

Returning to FIG. 2, a Vote Tabulation Engine 240 is responsible for tabulating votes cast by users/members for the submissions as noted in step 140 (FIG. 1). A Performance Scoring Engine 250 performs the functions and calculations noted in step 150 in accordance with the rule set 155 noted in FIG. 1 as well.

The recognition of winners and presentation of content/submitter performance statistics is done by a Publication Engine 260 which also handles the associated functions noted in step 160 noted above. Recommendations for members as noted for step 180 (FIG. 1) are handled by Recommender Engine 280. Archiving logic 290 takes care of the steps noted above for step 190 (FIG. 1).

An Advertising Engine 226 is also employed to feed ads within a datastream in accordance with desired objectives of the datastream provider and an advertiser providing the ad stock. This engine carries out the steps noted generally above in steps 122, 124 and 126 (FIG. 1). As noted above, advertising can be embedded both within the content itself as well as a social networking page presenting the submissions.

The site submissions to be presented and evaluated are presented through a Posting Engine 230, which can be of the same type known in the art for presenting a conventional social networking page or datastream to the user. A number of techniques for presenting the user's preferred data within a graphical interface (including a mobile interface in some instances) can be used for this purpose. As noted above, Posting Engine 220 is responsible for posting and collecting feedback on the submissions from users 205, collecting votes which are handled by Vote Tabulation Engine 240, and other operations as noted for steps 130, 140 in FIG. 1.

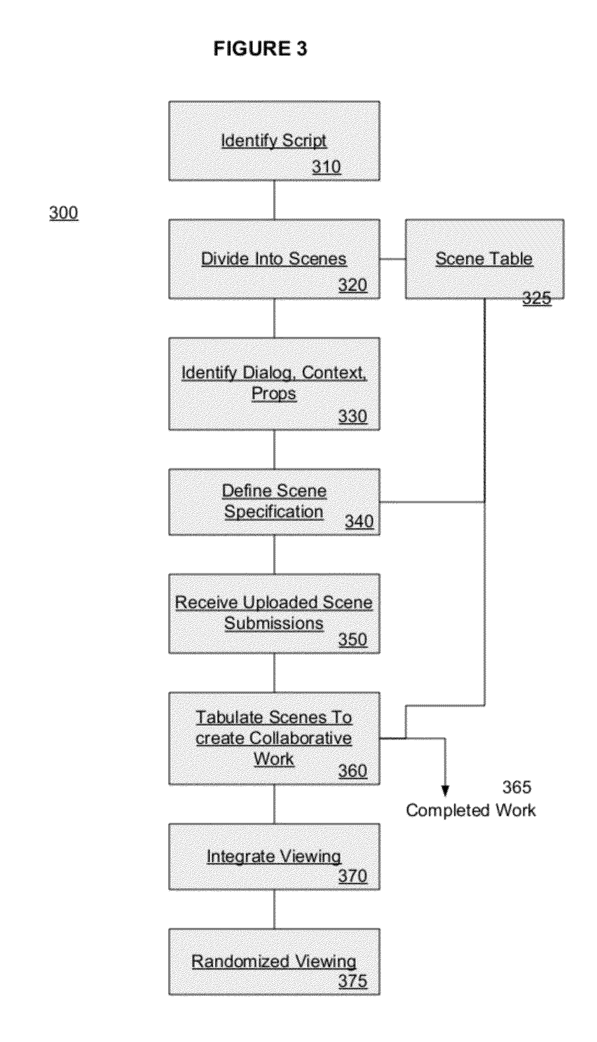

In another variant of the invention, contestants in the community can be enlisted or solicited to contribute, create and perform a unique form of community/collaborative work according to process 300 shown in FIG. 3. A script 310 is identified or created for the work; the script can be an original piece, or derived from a preexisting content. Script 310 is then divided into individual scenes or vignettes of a predetermined length at step 320. In some instances involving a preexisting work, the scenes may be taken from all or a portion of the entire work. For example, the movie/musical “Hair” could be divided into N different scenes, one for each song used in the work. The movie “Star Wars” could be divided into a set of “summary” scenes which present the story without all of the plot details, dialog, etc. From these summary scenes, a scene table 325 is created for the composite work 300, which table identifies all the unique scenes required for the particular work. In a preferred embodiment, as noted above, the scene is intentionally edited to require a small predetermined amount of time (e.g., from a few second to a few minutes) to perform. Other techniques/divisions could be used for different types of works.

The individual scenes 320 include dialog components for each speaking part/actor, and may be further specified at step 330 to include supporting components including a certain number of extras, props, contexts, etc. which must be included to perform the scene, as well as a time constraint. The dialog components and supporting components are then bundled into a specification 340 for contestants to review for a community work.

Members of the online community can then review the specifications 340 for the scenes and perform them as contestants in any manner they wish, subject to the time constraint and upload them at step 350 to contribute to the collaborative work. The rendition of the scenes may be done in any manner desired by the contestants; that is, it may be consistent with mood/tone of the original work, or it may be done as a spoof/farce, etc. The contestant entries are preferably tagged with the names of the contestants when they are contributed.

The member contributed entries 350 are then tabulated at step 360 to map them to scene table 325. When the members/contestants have contributed content for each scene and filled out table 325, a first virtual collaborative work 360 is completed. At this point, virtual collaborative work 360 may be compiled into a single physical work 365 and viewed that way at step 370, or viewed as a collage of disparate pieces.

In some embodiments the members/contestants are permitted to contribute multiple different versions of each scene 320. This allows for the option of compiling and viewing different versions of virtual collaborative work 360 at step 370. In a preferred approach, viewers can select which variant of each scene 320 they wish to see as part of a final collaborative work 360, to create their own customized viewing experience. As with the other embodiments above, viewers may be allowed to vote or express their rating for particular renditions, so that for each scene, a ranking can be maintained of the most popular performance.

In other cases viewers/consumers of the collaborative work content are permitted to view random synthesized versions of the work at step 375 so that no two performances are exactly alike. For example, in a 6 scene collaborative work, if each scene includes 10 different contributors and entries 350, the work can be played in 10⁶ different variations. In this manner the invention allows for a randomized and unique experience for the viewer.

Other modules may be advantageously employed or that are necessary for operation of a website to support the above processes might be included as well, but need not be described in detail her, for clarity, but could be implemented as desired. In addition, it is to be understood that these are merely examples, and other applications that allow for performance rating of content are clearly potential beneficiaries of the aforementioned techniques.

What is claimed is:

1. A method of operating an online interactive game show with a computing system comprising:
providing a set of game rules for a contestant to participate in a contest;
receiving a video submission entry from the contestant;
verifying that said video submission entry complies with said set of game rules;
posting said video submission entry when it passes said verifying step;
alerting contacts within a social network of said contestant to the presence of said video submission entry by posting a message on a posting wall for said contacts;
collecting votes cast by voters within a first voting period after said video submission entry is posted;
determining whether said video submission entry qualifies for a second stage of voting during a curation period which occurs after said first voting period has passed;
collecting votes cast by voters within a second voting period when said video entry submission qualifies for said second stage of voting;
determining whether said video submission entry qualifies as a winning submission during a winner review period which occurs after said second voting period has passed.

2. The method of claim 1, further including a step: automatically identifying an advertisement to be associated with said video submission entry, said advertisement being based on a category specified by said contestant.

3. The method of claim 1, further including a step: automatically identifying an advertisement to be associated with said video submission entry, said advertisement being based on a content of comments submitted during voting for said entry.

4. The method of claim 1, further including a step: automatically identifying an advertisement to be associated with said video submission entry, said advertisement being based on a geographic location identified for said entry.

5. The method of claim 1, further including a step: automatically identifying an advertisement to be associated with said video submission entry, said advertisement being overlaid with said entry during viewing of such entry within a viewing interface.

6. The method of claim 1, further including a step: automatically identifying an advertisement to be associated with said video submission entry, said advertisement being based on a content associated with prior entries viewed by a voter.

7. The method of claim 1, wherein said set of game rules include a restriction on a maximum length of said entry.

8. The method of claim 1, further including a step: automatically concatenating multiple video submission entries for viewing in a viewing interface.

9. The method of claim 7 wherein said multiple video submission entries are logically grouped according to a common category associated with each entry.

10. The method of claim 1, further including a step: based on a viewer viewing and/or voting on said video entry submission, recommending a second video submission entry to a viewer based on correlating said two entries.

11. The method of claim 1, further including a step: determining a performance score for said video submission entry based on both a number of views and a number of votes received during said first voting period or said second voting period.

12. The method of claim 1, further including a step: receiving a consideration fee from said contestant as a precondition to participation in said contest.

13. The method of claim 12, wherein said consideration fee includes virtual currency.

14. The method of claim 1, further including a step: combining one or more video submission entries into a single entry for viewing by online users.

15. The method of claim 14 wherein said one or more video submission entries are characterized by a common category.

16. The method of claim 14 wherein said one or more video submission entries each correspond to a different scene in a single composite work.

17. A method of creating a collaborative composite creative work comprising:
defining a set of individual scenes for the composite work;
providing a dialog script for each of said set of individual scenes;
receiving video submissions from users corresponding to said individual scenes, such that a first user user submission is associated with a first scene, and a second user submission is associated with a second scene;
generating a composite work containing all of said set of individual scenes, and such that multiple user submissions are included.

18. The method of claim 17 wherein different submissions for different scenes can be used for generating different versions of said composite work.

19. The method of claim 17 wherein said different versions of said composite work are created by randomly selecting submissions for individual scenes.

20. In a networked computer system that implements a performance based contest for a prize fund for content submitted by users the method comprising:
receiving with the networked computing system, a first content provided by a first user during a contest period;
wherein said first content includes a video based expression of an intended purpose of a request for the prize fund by the first user;
posting, with the networked computing system, the first content on a social networking site web page;
receiving, with the networked computing system, user votes expressing support for said first content;
causing the networked computing system to rate a performance of said first content to determine if said first content is eligible for some or all portions of said prize fund, said rating being based on both a comparison of a tally of said user votes received by said first content relative to other content submitted by other users as well as a separate contest rule set specifying at least one of the following conditions:
1) that said first content is one of the first N submissions received within a first time period, where N is a threshold adjustable by an authorized operator of the networked computing system; or
2) that said user votes must exceed a predefined threshold; or
3) that said first content is the first submission to receive M votes, where M is a threshold adjustable by an authorized operator of the networked computing system;
4) that said first content is the submission with the highest number of votes in the first P votes received, where P is a threshold adjustable by an authorized operator of the networked computing system;
wherein submissions of content are declared winning entries based on contest rules imposing conditions in addition to and separate from a requirement that they also receive a higher number of votes than other submissions within the contest period.
